(19) United States
(12) Patent Application Publication
(10) Pub. No.: US 2021/0283433 A1
(43) Pub. Date: Sep. 16, 2021

(54) Epidemic prevention mask having smoking and drinking functions

(71) Applicant: Nung YEH, New Taipei City (TW)

(72) Inventor: Nung YEH, New Taipei City (TW)

(21) Appl. No.: 17/120,273

(22) Filed: Dec. 14, 2020

(30) Foreign Application Priority Data
Mar. 16, 2020 (TW) 109108634
Mar. 26, 2020 (TW) 109203509
Apr. 8, 2020 (TW) 109111824
Sep. 7, 2020 (TW) 109130622

(51) Int. Cl. A62B 18/08; A41D 13/11; A62B 18/02

(52) U.S. Cl. CPC A62B 18/086; A62B 18/025; A41D 13/1107

(57) ABSTRACT

An epidemic prevention mask having smoking and drinking functions is provided, which includes a first mask body and at least one hole-covering part. The first mask body is adapted to cover a mouth position and a nose position of a user, and has at least one through-hole corresponding to the mouth position. A hole-covering part is connected to a hole edge of the through-hole and covers the through-hole. The epidemic prevention mask of the invention can be worn as a general epidemic prevention mask, and also enables users to smoke or drink a beverage while wearing the epidemic prevention mask.

### FIELD OF THE INVENTION

The invention relates to an epidemic prevention mask, and more particularly to an epidemic prevention mask that enables user to drink or smoke while wearing.

### BACKGROUND OF THE INVENTION

With the development of the industry nowadays, air pollution has become an increasingly serious environmental problem in modern society. Therefore, masks have become a commonly used personal item when people go out. The mask is worn on the mouth and nose positions of a user and covers the mouth and nose positions of the user. The main purpose of the mask is to isolate the mouth and nose positions of the user from the outside and filter the air flowing in and out the mouth and nose, so as to prevent harmful gases, odors, droplets from entering the user's mouth and nose. However, with regard to the mask in the prior art, the user cannot eat or drink while wearing the mask since the mask has already covered the user's mouth and nose.

### SUMMARY OF THE INVENTION

The invention provides an epidemic prevention mask having smoking and drinking functions. One of the objectives of the invention is to provide a mask having special artistic appearance, through which the mask can be worn as a general epidemic prevention mask and can also fulfill the functional requirements such as drinking. Thus, it is expected that the mask will be popular. Another objective is to provide an epidemic prevention mask that can be used for smoking and drinking and its unique film peeling structure. The unique film peeling structure is convenient for users to smoke or drink a beverage while wearing the epidemic prevention mask. Also, wearing the mask can prevent germs, dust and droplets from entering the mouth and nose to cause sickness. Therefore, the mask is functionally required and has the effect of avoiding epidemics. The invention is expected to provide amusement to the user wearing the mask and be contributed to the people of your country as a pioneer in epidemic prevention.

An epidemic prevention mask having smoking and drinking functions provided by an embodiment of the invention includes a first mask body and at least one hole-covering part. The first mask body is adapted to cover a mouth position and a nose position of a user. The first mask body has at least one through-hole corresponding to the mouth position. The at least one hole-covering part is connected to a hole edge of the at least one through-hole and covers the at least one through-hole.

An epidemic prevention mask having smoking and drinking functions provided by another embodiment of the invention includes a first mask body, a second mask body, a first connection structure, a third mask body, and a second connection structure. The first mask body has an opening corresponding to a mouth position of a user. The second mask body is connected to the first mask body and covers the opening. The second mask body has at least one through-hole corresponding to the opening. The second mask body further has a first side edge and a second side edge opposite to each other. The first connection structure is arranged on the first side edge of the second mask body. The third mask body has a third side edge and a fourth side edge opposite to each other. The third side edge is fixedly connected to the second side edge of the second mask body. The fourth side edge corresponds to the first side edge of the second mask body. The second connection structure is arranged on the fourth side edge of the third mask body and corresponds to the first connection structure. The second connection structure and the first connection structure are separable from and connectable to each other, so that the fourth side edge of the third mask body is detachably connected to the first side edge of the second mask body.

The epidemic prevention mask according to an embodiment of the invention has the hole-covering part covering the through-hole on the first mask body, so that the through-hole can be used as a quasi-through-hole. Therefore, when a user wants to smoke or drink a beverage while wearing the epidemic prevention mask, the user can push-through the quasi-through-hole to form a through-hole and insert a cigarette or straw into the through-hole, or lift the hole-covering part by the second mask body to expose the through-hole. In this way, the user can smoke or drink a beverage through the through-hole. On the other hand, the invention also provides another epidemic prevention mask having smoking and drinking functions, including a first mask body having an opening, a second mask body having a through-hole, and a third mask body covering the through-hole. The through-hole is communicated with the opening. The user can lift the third mask body from the second mask body to expose the through-hole of the second mask body while wearing the epidemic prevention mask, thereby smoking or drinking a beverage while wearing the epidemic prevention mask. As a result, the user can directly smoke or drink a beverage while wearing the epidemic prevention mask, which is more convenient to use.

The humanized and practical design of the invention greatly meets actual needs. It specifically overcomes the existing shortcomings. Compared to the prior art, the invention clearly has breakthrough advancement, has improvement in efficacy, and is easy to achieve. The features and advantages of the invention may be better understood from the following description, which is to be read with reference to the accompanying drawings.

### BRIEF DESCRIPTION OF THE DRAWINGS

The invention will become more readily apparent to those ordinarily skilled in the art after reviewing the following detailed description and accompanying drawings, in which:

FIG. 1A is a schematic diagram of the back side of an epidemic prevention mask having smoking and drinking functions according to an embodiment of the invention;

FIG. 1B is a schematic exploded view of the back side of a first mask body and the back side of a second mask of FIG. 1A;

FIG. 2 is a schematic exploded view of the first mask body and the second mask body of FIG. 1A;

FIG. 3 is a schematic diagram of the front side of the combination of a first mask body and a second mask body according to another embodiment of the invention;

FIG. 4 is a schematic diagram of the back side of an epidemic prevention mask according to another embodiment of the invention;

FIG. 5A is a schematic diagram of the front side of a first mask body according to another embodiment of the invention;

FIG. 5B is a partial enlarged view of FIG. 5A;

FIG. 6 is a schematic diagram of the front side of the first mask body of FIG. 4 and FIG. 5A, wherein a cigarette is inserted to a first through-hole of the first mask body;

FIG. 7 is a schematic diagram of the front side of an epidemic prevention mask to which a straw is inserted according to another embodiment of the invention;

FIG. 8 is a schematic diagram of the front side of the epidemic prevention mask of FIG. 7 to which a straw is not inserted;

FIG. 9 is a schematic diagram of the front side of the epidemic prevention mask of FIG. 7 to which a cigarette is inserted;

FIG. 10 is a schematic diagram of the back side of an epidemic prevention mask according to another embodiment of the invention;

FIG. 11 is a schematic exploded view of a first mask body and a second mask body of FIG. 10;

FIG. 12 is a schematic diagram of the front side of an epidemic prevention mask according to another embodiment of the invention;

FIG. 13 is a schematic exploded view of a first mask body and a second mask body of FIG. 12;

FIG. 14 is a schematic diagram of the front side of an epidemic prevention mask according to another embodiment of the invention;

FIG. 15 is a schematic diagram of the front side of an epidemic prevention mask having smoking and drinking functions according to another embodiment of the invention;

FIG. 16 is a schematic exploded view of a first mask body, a second mask body, and a third mask body of FIG. 15; and

FIG. 17 is a schematic diagram of the back side of the second mask body of FIG. 16 connected to the front side of the first mask body.

### DETAILED DESCRIPTION OF PREFERRED EMBODIMENTS

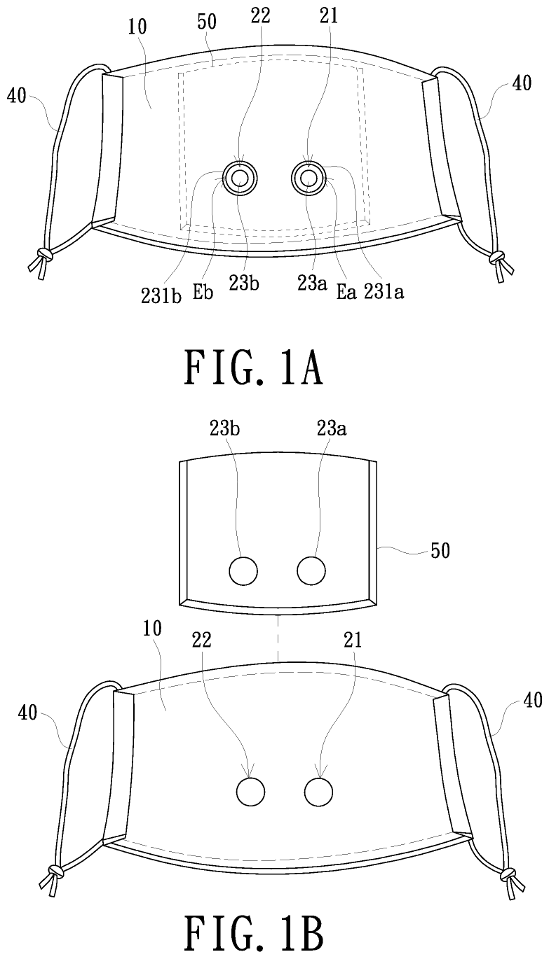

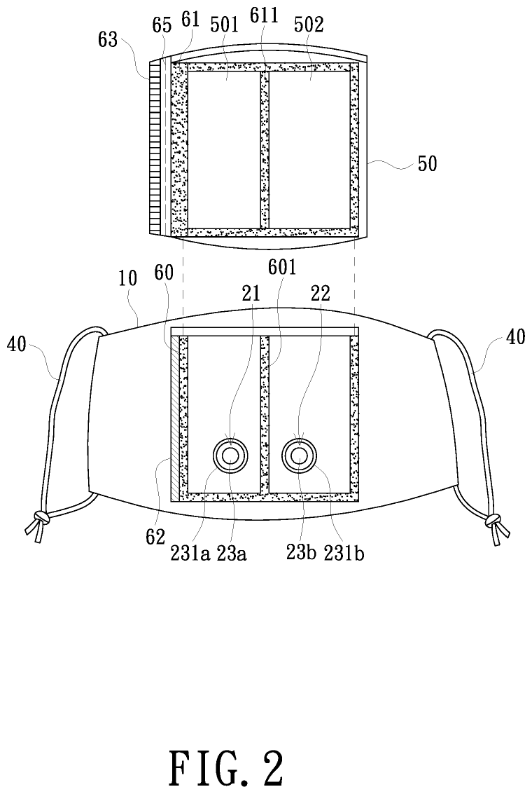

The structure composition and generated effects and advantages in the invention are described as follows with the drawings. However, the accompanying drawings are only provided for reference and illustration, and are not intended to limit the invention. The embodiments of the invention are described in detail as follows. Please refer to FIG. 1A to FIG. 2, which show an epidemic prevention mask that can be used for smoking and drinking according to an embodiment of the invention. The epidemic prevention mask includes the following elements: a first mask body 10 and hole-covering parts. The hole-covering parts of this embodiment can include a first hole-covering part 23a and a second hole-covering part 23b, but the number of the hole-covering parts is not limited thereto. The first mask body 10 is adapted to cover a mouth position and a nose position of a user, and the first mask body 10 has through-holes corresponding to the mouth position. The through-holes in this embodiment can include a first through-hole 21 and a second through-hole 22, but the number of the through-holes is not limited thereto. The hole-covering parts are connected to hole edges of the through-holes and cover the through-holes, respectively. Specifically, in this embodiment, the first hole-covering part 23a is connected to the hole edge Ea of the first through-hole 21 and covers the first through-hole 21, and the second hole-covering part 23b is connected to the hole edge Eb of the second through-hole 22 and covers the second through-hole 22. Incidentally, the hole-covering parts (i.e., the first hole-covering part 23a and the second hole-covering part 23b) are, for example, hole-covering films.

In addition, the epidemic prevention mask can further include a second mask body 50. The second mask body 50 is combined with the first mask body 10 and connected to the hole-covering parts (i.e., the first hole-covering part 23a and the second hole-covering part 23b in this embodiment). The second mask body 50 is adapted to be lifted from the first mask body 10 and remove the hole-covering parts from the through-holes. In detail, the first hole-covering part 23a is detached from the first through-hole 21 and the second hole-covering part 23b is detached from the second through-hole 22 when the second mask body 50 is lifted from the first mask body 10. Thus, the second mask body 50 can be used as a film peeling structure. Incidentally, the first mask body 10 can be processed by crimping or cutting at the position where the hole edge Ea is connected to the first hole-covering part 23a, thereby forming a pre-cut opening corresponding to the at least one through-hole. For example, a first pre-cut opening 231a corresponding to the first through-hole 21 is formed in the aforementioned processing manner. Similarly, the position on the first mask body 10 where the hole edge Eb is connected to the second hole-covering part 23b can also be processed in the aforementioned manner to form a second pre-cut opening 231b corresponding to the second through-hole 22. The first mask body 10 can be used to filter pollutants such as harmful gases, bacteria, or droplets in the air. The first mask body 10 covers a mouth position and a nose position of the user while the user wears the epidemic prevention mask. The second mask body 50 can correspond to the user's mouth position but not correspond to the nose position, or the second mask body 50 can correspond to the mouth position and the nose position of the user. The first mask body 10 can have a different shape, such as a rectangle shape, a diamond shape, etc., to adapt to the mouth position and the nose position of the user.

The first mask body 10 and the second mask body 50 are mainly composed of cotton or nonwoven fabric, but these materials are not used to limit the scope of the invention. The first mask body 10 and the second mask body 50 composed of any material are within the scope of the invention. For example, each of the first mask body 10 and the second mask body 50 can include a water repellent layer, a filter layer, and a skin-friendly layer. In another embodiment, the overlapping part of the first mask body 10 and the second mask body 50 can include a water repellent layer, a filter layer, and a skin-friendly layer, while the material of the other parts of the first cover 10 and the second cover 50 is not limited. In this embodiment, the first mask body 10 is preferably the mask body of a dust-proof mask or a medical mask, such as a flat mask for dust-proof or medical use, or the first mask body 10 can also be the mask body of an N95 series respirator. Preferably, the first mask body 10 contains active carbon to filter particles in the air. In another embodiment, the first mask body 10 can also be a non-medical mask. In this embodiment, the shape of the first mask body 10 is, for example, a C-shaped, clam-shaped, duck-shaped, mouth-shaped, or folded structure.

With regard to the unique film peeling structure according to the embodiment of the invention as shown in FIG. 1, FIG. 1B and FIG. 2, the position the part of the second mask body 50 corresponding to the first hole-covering part 23a and the second hole-covering part 23b can be processed with different adhesion strengths by chemical technology, so that the first hole-covering part 23a and the second hole-covering part 23b are connected to the second mask body 50. The first through-hole 21 and the second through-hole 22 of the first mask body 10 are in the quasi-through-hole form before lifting the second mask body 50 from the first mask body 10. That is, the first hole-covering part 23a has not yet been detached from the first through-hole 21, and the second hole-covering part 23b has not yet been detached from the second through-hole 22, so that the first through-hole 21 and the second through-hole 22 do not form openings and therefore there is no exposure at all and no hole or gap exist. To use the through-holes, the second mask body 50 is lifted in a direction from left, right, top, or bottom until the first hole-covering part 23a and the second hole-covering part 23b are uncovered. The first hole-covering part 23a and the second hole-covering part 23b are attached to the second mask body 50 after the second mask body 50 is lifted from the first mask body 10, which makes the first through-hole 21 and the second through-hole 22 to be presented and exposed, and therefore the epidemic prevention mask of the invention is very easy to use.

As shown in FIG. 2, the epidemic prevention mask can further include a first connection structure 60 and a second connection structure 61. The second connection structure 61 is arranged on a side edge of the second mask body 50. The first connection structure 60 is arranged on the first mask body 10 and corresponds to the second connection structure 61. The first connection structure 60 and the second connection structure 61 are separable from and connectable to each other. Specifically, the second connection structure 61 can be arranged around the second mask body 50, and the first connection structure 60 can be arranged on the front side of the first mask body 10. Thus, the first mask body 10 and the second mask body 50 can form an easily detachable connection. The first connection structure 60 and the second connection structure 61 are, for example, objects such as touch fasteners, adhesives, or the like that allow the first mask body 10 to be combined with the second mask body 50.

The first connection structure 60 can further have a first dividing part 601 arranged on the first mask body 10 and positioned between the first through-hole 21 and the second through-hole 22. The second connection structure 61 can further has a second dividing part 611 arranged on the second mask body 50 and separable from and connectable to the first dividing part 601. The second dividing part 611 divides the second mask body 50 into a first part 501 connected to the first hole-covering part 23a and a second part 502 connected to the second hole-covering part 23b. The first part 501 and the second part 502 are adapted to be lifted from the first mask body 10 by taking the first dividing part 601 and the second dividing part 611 connected to each other as an axis. In this way, the user can choose to expose only the first through-hole 21 or the second through-hole 22 to enhance the flexibility in use.

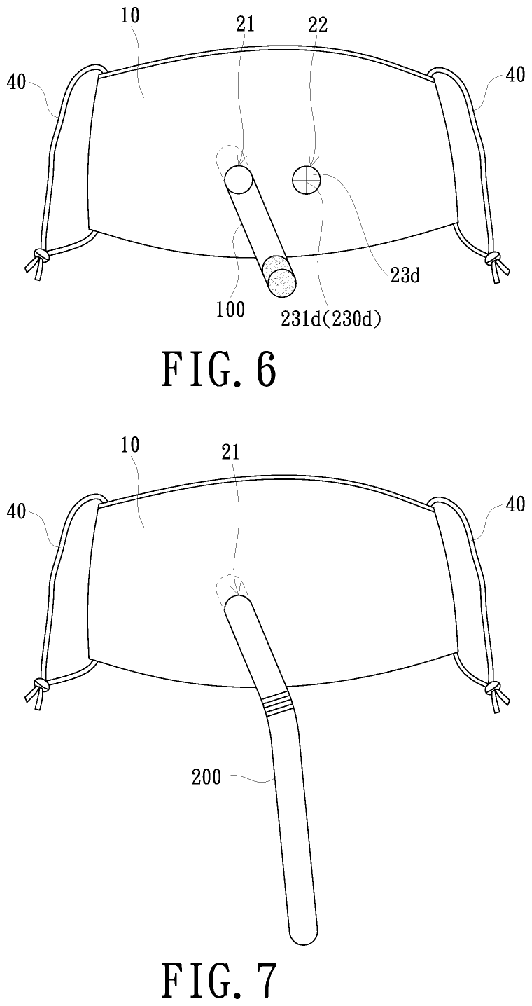

In addition, the epidemic prevention mask can further include a first positioning structure 62 and a second positioning structure 63. The second positioning structure 63 is arranged on a side edge of the second mask body 50. The first positioning structure 62 is arranged on the first mask body 10 and corresponding to the second positioning structure 63. The first positioning structure 62 and the second positioning structure 63 are adapted to slot to each other. In brief, the aforementioned side edge of the second mask body 50 can be positioned via the second positioning structure 63 and combined with the first positioning structure 62 of the first mask body 10. The second positioning structure 63 is, for example, a processed rigid edge sleeve. The first positioning structure 62 is, for example, a processed slit groove. Specifically, the second positioning structure 63 (i.e., the aforementioned rigid edge sleeve) can be folded along a rigid cloth edge 65 toward a direction approaching the second connection structure 61, and the folded second positioning structure 63 can be inserted into the first positioning structure 62 (i.e., the aforementioned slit groove) of the first mask body 10, so that the second mask body 50 can be easily combined with the first mask body 10. As described above, the second mask body 50 can be combined with the first connection structure 60 of the first mask body 10 via the second connection structure 61. The first connection structure 60 and the second connection structure 61 are, for example, materials such as touch fasteners or chemical adhesives that allow the first mask body 10 and the second mask body 50 to be bonded to each other. Thus, when the user wants to use the first through-hole 21 or the second through-hole 22 for inserting a cigarette 100 (shown in FIG. 6) or a straw 200 (shown in FIG. 7), the second mask body 50 is lifted first, so that the second connection structure 61 (such as s touch fastener) on the back side of the second mask body 50 is detached from the first connection structure 60. In this way, the second mask body 50 can be separated from the first mask body 10, and the first hole-covering part 23a and the second hole-covering part 23b can be attached to the second mask body 50. In other embodiments, the user can also push away the first hole-covering part 23a or the second hole-covering part 23b to expose the first through-hole 21 or the second through-hole 22, as described in detail below.

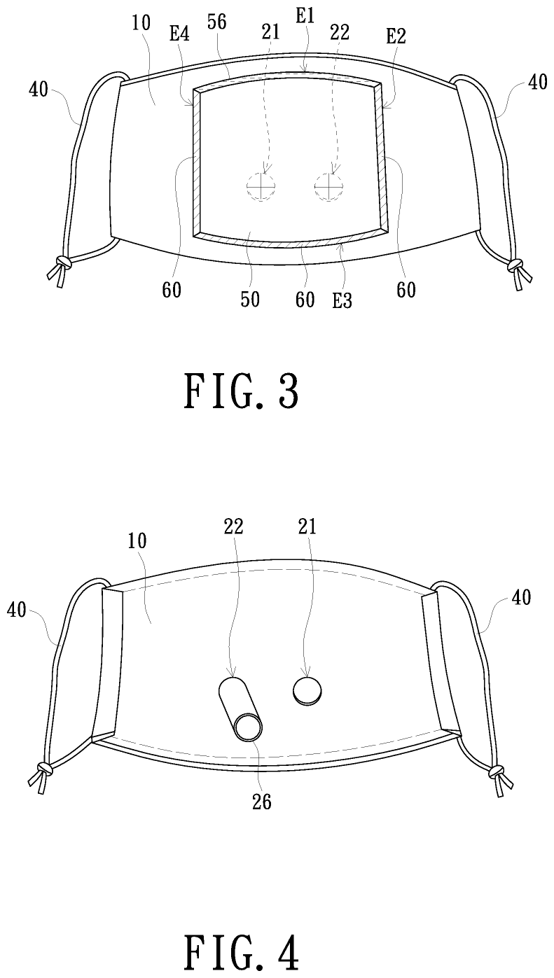

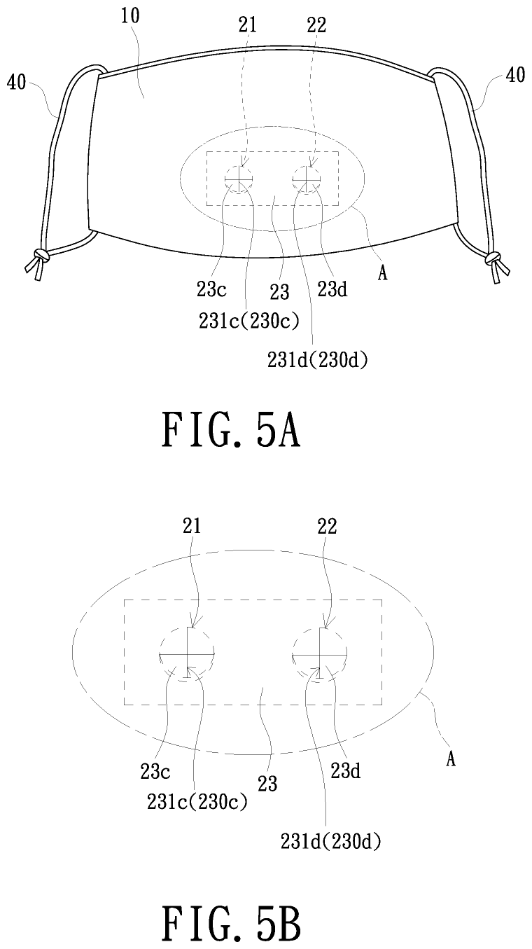

As shown in FIG. 3, the epidemic prevention mask of the invention can further include a body connection structure 56. The second mask body 50 has a plurality of edges E1, E2, E3, and E4. The body connection structure 56 is arranged on the edge E1 of the second mask body 50. The second connection structure 61 is arranged on the other edges E2, E3, and E4 of the second mask body 50. The body connection structure 56 is fixedly connected to the first mask body 10. In detail, the edge E1 of the second mask body 50 is fixed to the first mask body 10 via the body connection structure 56, and the edge E1 of the second mask body 50 cannot be separated from the first mask body 10. In this embodiment, the body connection structure 56 is, for example, a stitch that secures the connection between the first mask body 10 and the second mask body 50. Furthermore, the body connection structure 56 can be processed on the edge E1 of the second mask body 50, so that the edge E1 can be stitched to the first mask body 10. Also, the body connection structure 56 can also be processed on one of the other edges E2, E3 and E4 of the second mask body 50, so that the second mask body 50 can be stitched to the first mask body 10. FIG. 5A is a schematic diagram of the front side of a first mask body according to another embodiment of the invention. FIG. 5B is an enlarged view of an area A in FIG. 5A. As shown in FIG. 5A and FIG. 5B, the aforementioned hole-covering part can have a push-through structure. In other words, the first hole-covering part 23c of FIG. 5A can have a push-through structure 230c, and the second hole-covering part 23d can have a push-through structure 230d. The push-through structure 230c can include a pre-cut line 231c, and similarly, the push-through structure 230d can also include a pre-cut line 231d. Specifically, the pre-cut lines 231c and 231d can be formed by folding or by cutting. The second mask body of FIG. 5A can be arranged as a protective tape 23. Therefore, the first through-hole 21 and the second through-hole 22 are not yet open. The protective tape 23 can be adhered to the pre-cut lines 231c and 231d that have been cut (or sheared) to serve as a fixed protective structure. Since the protective tape 23 also forms opposing edges and has the feature of being easy to lift, the protective tape 23 can be combined with the first mask body 10 and seal the push-through structures 230c and 230d. Please refer to FIG. 6. The entire structure of the epidemic prevention mask of this embodiment is not merely used as a general epidemic prevention mask. When there is a need such as smoking or drinking, the user can uncover the second mask body (i.e., the protective tape 23) and insert a cigarette 100 or a straw 200 (shown in FIG. 7) into the push-through structure 230c (shown in FIG. 5A) or the push-through structure 230d from the front side of the first mask body 10, which is a functional use.

The producing method of the push-through structure 230c or 230d is as described below. As shown in the embodiment of FIG. 5A and FIG. 6 and as described above, the first mask body 10 has the first through-hole 21 and the second through-hole 22. The first hole-covering part 23c of the first through-hole 21 and the second hole-covering part 23d of the second through-hole 22 can be first cut into pre-cut lines 231c and 231d of a cross shape or an “*” shape, thereby forming the push-through structure 230c or 230d. In addition, a protective tape 23 is used to seal the push-through structure 230c or 230d on the back side of the first mask body 10. In this way, the epidemic prevention mask of this embodiment is not merely used as a general mask. When there is a need such as smoking or drinking, user can peel or remove the protective tape 23 on the back side of the first mask body 10 to make the openings of the pre-cut line 231c and 231d expose, and insert the cigarette 100 or the straw 200 (shown in FIG. 7), which is a functional use.

The processing method of the pre-cut lines 231c and 231d is not limited to cutting. As shown in FIG. 5A and FIG. 6, in the aforementioned embodiment, the pre-cut lines 231c and 231d are press-folded by a special chemical fusion technology, so that the first hole-covering part 23c and the second hole-covering part 23d form the push-through structures 230c and 230d, respectively. When the user needs functional purpose such as smoking or drinking a beverage, the user can lift the second mask body 50 (i.e., the protective tape 23) and use a cigarette 100, a straw 200 (shown in FIG. 7), an exhalation tube 26 (shown in FIG. 4), or other suitable objects to push through or insert to the epidemic prevention mask. In order to prevent harmful gases from entering the mouth or nose, the diameters of the first hole-covering part 23c and the second hole-covering part 23d are sufficient only for inserting an object such as a cigarette 100 or a straw 200 for functional use such as smoking or drinking.

In the aforementioned application embodiment, when the first through-hole 21 is used for inserting the cigarette 100 as shown in FIG. 6, the second through-hole 22 can be used to expel the gas exhaled by the user while smoking. On the other hand, when the user smokes with the cigarette 100 inserted into the first through-hole 21, an exhalation tube 26 can be arranged to the second through-hole 22 as shown in FIG. 4 to expel the gas to the outside. The exhalation tube 26 is, for example, inserted into the second through-hole 22 from the back side (or inner side) of the first mask body 10, but not limited thereto. In each embodiment, two straps 40 are respectively connected to the left and right sides of the first mask body 10. The two straps 40 are used to loop around the user's ears, so that the first mask body 10 can be fixed to the mouth and nose positions of the user.

As shown in FIG. 7, the number of the through-holes illustrated in this embodiment is one (i.e., the first through-hole 21). The first through-hole 21 of the first mask body 10 can also be used for inserting a straw 200 for the user to drink an external beverage. Therefore, when the user wants to drink water or other beverages, the straw 200 can be inserted into the first through-hole 21 to make the straw 200 contact the user's mouth, so the user can use the straw 200 to drink water or other beverages without taking the first mask body 10 off.

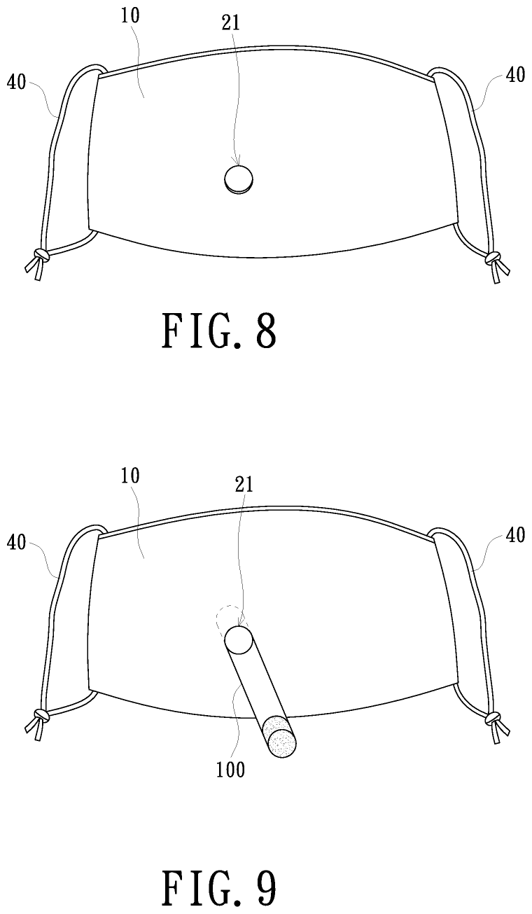

As shown in FIG. 8 and FIG. 9, in an application embodiment of the invention, the first through-hole 21 can be used to insert a cigarette 100 for the user to smoke. When the user wants to smoke, the cigarette 100 can be inserted into the first through-hole 21 to make the cigarette 100 contact the user's mouth, so that the user can smoke. Therefore, the user can smoke while wearing the first mask body 10 without taking the first mask body 10 off.

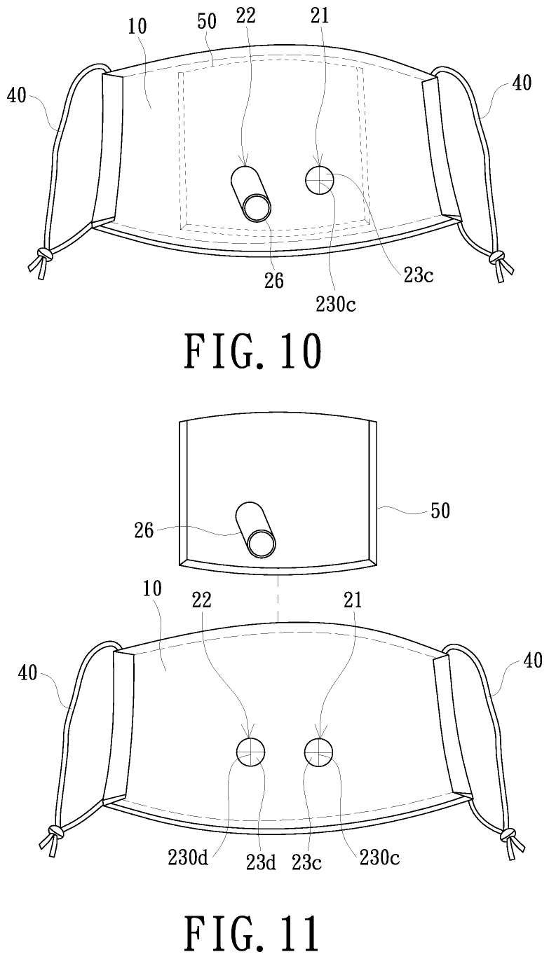

As shown in FIG. 10, the epidemic prevention mask having smoking and drinking functions includes an exhalation tube (guide tube) 26 installed and fixed to the second through-hole 22 of the first mask body 10. As such, the exhalation tube 26 can extend from the inner side of the first mask body 10 (i.e., the back side of the first mask body 10) to the mouth position of the user. The exhalation tube 26 can be detachable, for example. In detail, the cigarette 100 (shown in FIG. 6) can be inserted in the first through-hole 21 from the push-through structure 230c of the first hole-covering part 23c. The exhalation tube 26 is inserted to the first mask body 10 only when the cigarette 100 (shown in FIG. 6) is inserted in the first through-hole 21. The user can adjust the position of the exhalation tube 26 for the air exhaled from the mouth. Alternatively, the exhalation tube 26 can be fixedly positioned at the first mask body 10 corresponding to the mouth position of the user, and the user can exhale the gas through the exhalation tube 26 while smoke. As shown in FIG. 11, the exhalation tube 26 can also be arranged and fixed to the inner side of the second mask body 50, and the position of the exhalation tube 26 on the second mask body 50 corresponds to the position of the second through-hole 22 of the first mask body 10. Specifically, when the second mask body 50 is mounted to the first mask body 10, the exhalation tube 26 can correspond to the position of the second through-hole 22 of the first mask body 10 and be inserted to the second through-hole 22 from the push-through structure 230d of the second hole-covering part 23d. The cigarette 100 (shown in FIG. 6) can be inserted to the first through-hole 21 through the push-through structure 230c of the first hole-covering part 23c. Thus, the exhalation tube 26 can reach the user's mouth position through the second through-hole 22, so the user can exhale smoking gas through the exhalation tube 26.

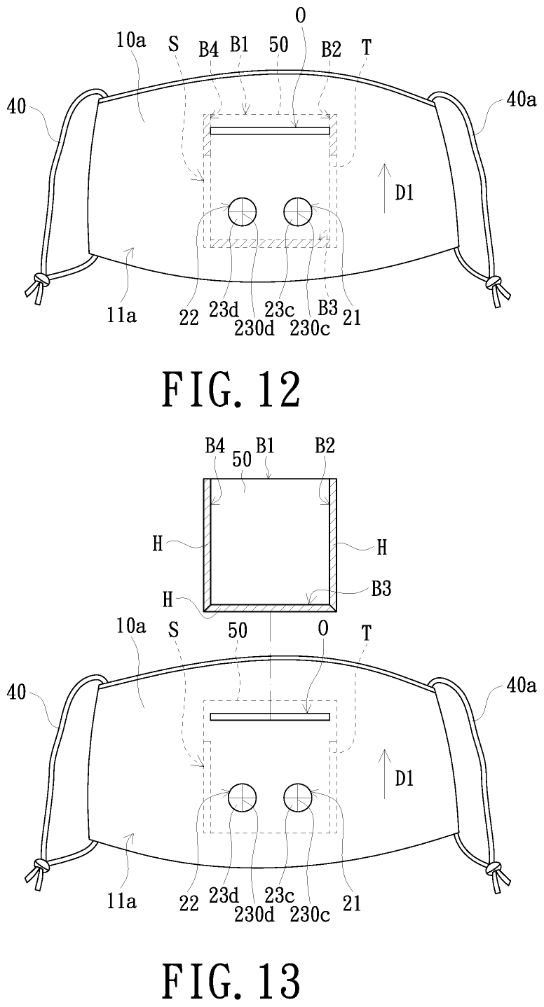

FIG. 12 is a schematic diagram of the front side of an epidemic prevention mask according to another embodiment of the invention. FIG. 13 is a schematic exploded view of a first mask body and a second mask body of FIG. 12. Please refer to FIG. 12 and FIG. 13. In addition to the second mask body 50, the epidemic prevention mask further includes at least two guide way structures T opposite to each other. The number of the guide way structures T in this embodiment is two, but the number of the guide way structures T is not limited thereto. The guide way structures T are arranged in the first mask body 10a. The second mask body 50 is connected to the guide way structures T and is adapted to overlap at least one hole-covering part (shown as the first hole-covering part 23c and the second hole-covering part 23d in this embodiment). The second mask body 50 is adapted to move along the guide way structures T. The at least one hole-covering part of this embodiment is illustrated as a first hole-covering part 23c having a push-through structure 230c and a second hole-covering part 23d having a push-through structure 230d. It can be understood that the at least one hole-covering part can also be arranged as the first hole-covering part 23a and the second hole-covering part 23b of FIG. 1A.

The side surface 11a of the first mask body 10a of the present embodiment has an insertion opening O. The second mask body 50 extends into the first mask body 10a through the insertion opening O and overlaps the first hole-covering part 23c and the second hole-covering part 23d. The second mask body 50 is adapted to move through the insertion opening O. In this embodiment, an internal space S communicated with the insertion opening O can be formed in the first mask body 10a. The internal space S can be formed between two different internal layers of the first mask body 10a. For example, the two internal layers can be two of the aforementioned water repellent layer, filter layer, and skin-friendly layer, but are not limited thereto. When a user wants to smoke or drink a beverage, the second mask body 50 can be moved toward a direction D1 from the insertion opening O, so that the push-through structures 230c and 230d do not overlap the second mask body 50. Thus, an object such as a cigarette 100 (shown in FIG. 6) or a straw 200 (shown in FIG. 7) is able to be inserted into the push-through structures 230c and 230d and reach the user's mouth position. Similarly, when the user has finished smoking or drinking the beverage, the second mask body 50 can be moved to a position overlapping with the push-through structures 230c and 230d (for example, as shown in FIG. 12). Incidentally, the side surface 11a of this embodiment is, for example, the surface that does not touch the user's face when the user wears the epidemic prevention mask. However, in other embodiments, the side surface 11a can also be the surface that touches the user's face when the user wears the epidemic prevention mask. In addition, in this embodiment, the shape of the second mask body 50 can be a square, but is not limited thereto.

Please refer further to FIG. 13. The epidemic prevention mask of this embodiment can further include a hard material structure H arranged on at least one of the side edges B1, B2, B3 and B4 of the second mask body 50. The hard material structure H is, for example, adapted to be combined with the guide way structures T, so that the side edges B2 and B4 of the second mask body 50 of this embodiment can move along the two guide way structures T. Specifically, the material of the hard material structure H can be less susceptible to deformation than the material of the second mask body 50. For example, the hard material structure H can be the rigid cloth edge as described above, but is not limited thereto. The hard material structure H of this embodiment is arranged on the side edges B2, B3, and B4 of the second mask body 50, so that the second mask body 50 can move smoothly in the internal space S. However, in other embodiments, the hard material structure H can also be arranged on the side edge B1 of the second mask body 50 close to the insertion opening O, or arranged on the side edge B3 of the second mask body 50 away from the insertion opening O.

It can be understood that the positions of the insertion opening O and the guide way structures T are not limited to the positions shown in FIG. 12 and FIG. 13. For example, in another embodiment, the insertion opening O can also be positioned between the first hole-covering part 23c and the strap 40a, and the two guide way structures T can be arranged at a position in the internal space S and near the side edge B1 and B3 of the second mask body 50. Thus, the second mask body 50 can move along a direction substantially perpendicular to the direction D1 to a position overlapping the first hole-covering part 23c but not overlapping the second hole-covering part 23d, so that the user can use the push-through structure 230d of the second hole-covering part 23d. In addition, the second mask body 50 can also be moved along a direction substantially perpendicular to the direction D1 to a position that does not overlap the first hole-covering part 23c and the second hole-covering part 23d, so that the user can use the push-through structures 230c and 230d. Similarly, in other embodiments, the insertion opening O can be positioned between the second hole-covering part 23d and the strap 40, and the rest of the detailed structure is similar to the foregoing.

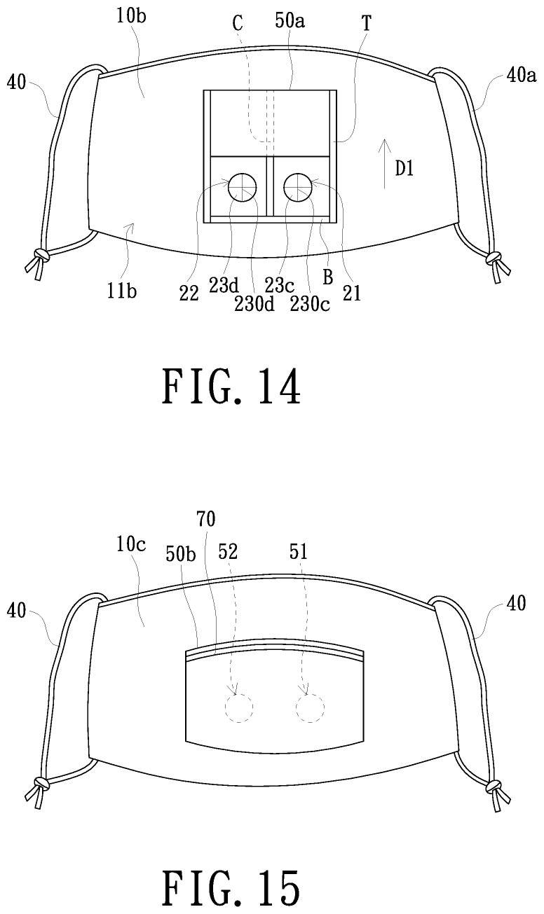

FIG. 14 is a schematic diagram of the front side of an epidemic prevention mask according to another embodiment of the invention. Please refer to FIG. 14. The difference from FIG. 12 is that the guide way structure T of this embodiment is arranged on the outside surface 11b of the first mask body 10b. Similarly, when the user wants to smoke or drink a beverage, the second mask body 50a can be moved in the direction D1 to expose the push-through structure 230c of the first hole-covering part 23c and the push-through structure 230d of the second hole-covering part 23d, so that the cigarette 100 (shown in FIG. 6) or straw 200 (shown in FIG. 7) can be inserted into the push-through structures 230c and 230d. When the user has finished smoking or drinking a beverage, the second mask body 50a can be moved to a position overlapping with the push-through structures 230c and 230d. Similar to the embodiment of FIG. 12, the outside surface 11b of the first mask body 10b can be the surface that does not touch the user's face when the user wears the epidemic prevention mask or can be the surface that touches the user's face when the user wears the epidemic prevention mask.

It can be understood that the positions of the guide way structures T is not limited to the positions shown in FIG. 14. In another embodiment, the two guide way structures T can be arranged along a direction substantially perpendicular to the direction D1 and positioned on opposite sides of the first hole-covering part 23c and the second hole-covering part 23d. The second mask body 50a can be moved along the direction substantially perpendicular to the direction D1 to a position overlapping the first hole-covering part 23c but not overlapping the second hole-covering part 23d, so that the user can use the push-through structure 230d of the second hole-covering part 23d. Similarly, the second mask body 50a can also be moved to a position overlapping the second hole-covering part 23d but not overlapping the first hole-covering part 23c, so that the user can use the push-through structure 230c of the first hole-covering part 23c. In addition, the epidemic prevention mask of FIG. 14 can further include an enclosing structure B. The enclosing structure B can be arranged between the two guide way structures T and positioned on the direction D1 in which the second mask body 50a moves. In detail, the enclosing structure B can be arranged between the ends of the two guide way structures T to prevent the second mask body 50a from being detached from the two guide way structures T when the second mask body 50a moves to the ends of the two guide way structures T. On the other hand, the epidemic prevention mask of FIG. 14 can further include a column C arranged between the two guide way structures T and can be substantially parallel to the two guide way structures T. Thus, the second mask body 50a can be prevented from being tilted outward (that is, in a direction away from the first mask body 10b), deforming, or even popping out.

Incidentally, the second mask body 50 of FIG. 1A of the invention can be connected to the first mask body 10 in a detachable manner. Similarly, the second mask body 50 of FIG. 12 of the invention can also be connected to the first mask body 10a in a detachable manner. After using the epidemic prevention mask for a period of time, the user only needs to detach the second mask body 50 from the first mask body 10 of FIG. 1A (or the first mask body 10a of FIG. 12) and places in a new second mask body 50, and the filtering function of the second mask body 50 can be restored to the initial state, so the service life of the epidemic prevention mask can be prolonged, and the best filtering effect can be maintained for a long time. In the embodiments of FIG. 1A and FIG. 12, the user can also choose a different first mask body 10 (or first mask body 10a) to match a different second mask body 50 to meet the needs of use. At the same time, it also allows the entire mask to look different with an aesthetic effect.

In the aforementioned embodiments, the epidemic prevention mask uses the hole-covering parts (such as the first hole-covering part 23c and the second hole-covering part 23d) to cover the through-holes (such as the first through-hole 21 and the second through-hole 22) of the first mask body 10 (or the first mask body 10a, the first mask body 10b), so that the through-holes can be used as quasi-through-holes. Therefore, when the user wants to smoke or drink a beverage while wearing the epidemic prevention mask, the user can insert the cigarette 100 or the straw 200 into the aforementioned quasi-through-hole, or uncover the aforementioned hole-covering part via the second mask body 50 to expose the aforementioned through-hole. In this way, the user can smoke or drink a beverage through the through-hole, which is more convenient to use.

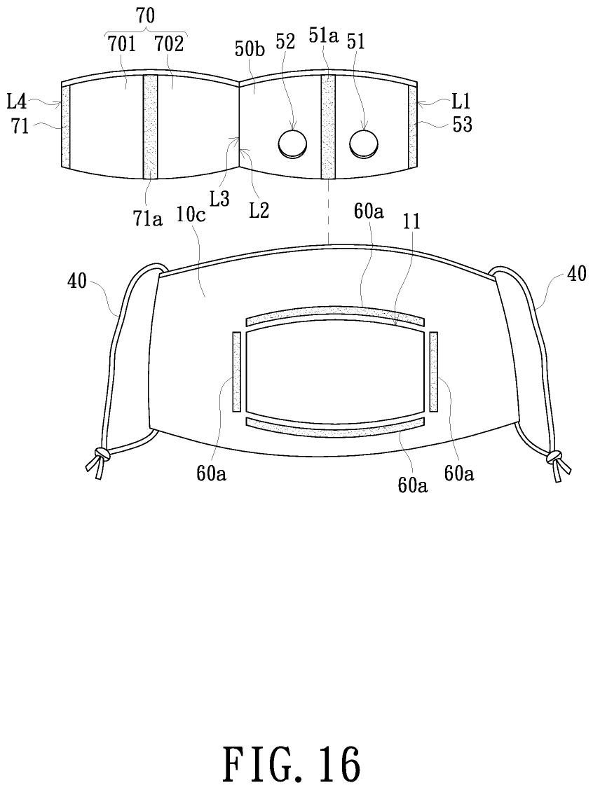

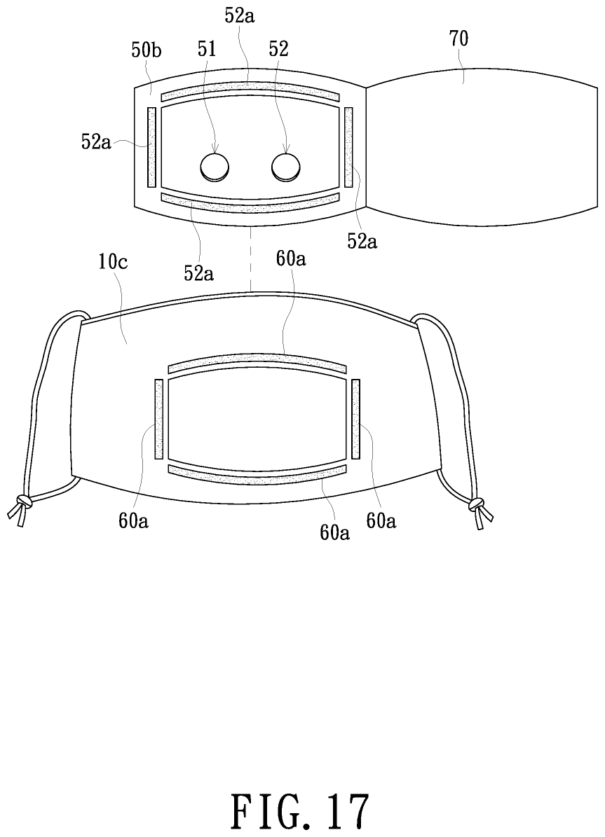

FIG. 15 and FIG. 16 show an epidemic prevention mask according to an embodiment of the invention. The epidemic prevention mask includes a first mask body 10c, a second mask body 50b, a first connection structure 53, a third mask body 70 and a second connection structure 71. The first mask body 10c has an opening 11 corresponding to a mouth position of a user. It can be understood that, in addition to corresponding to the mouth position of the user, the opening 11 can also correspond to a nose position of the user. The second mask body 50b is connected to the first mask body 10c and covers an opening 11. The second mask body 50b has through-holes corresponding to the opening 11. The second mask body 50b further has a first side edge L1 and a second mask body 50b opposite to each other. The through-holes include a first through-hole 51 close to the first side edge L1 and a second through-hole 52 close to the second side edge L2. The first connection structure 53 is arranged on the first side edge L1 of the second mask body 50b. The third mask body 70 has a third side edge L3 and a fourth side edge L4 opposite to each other. The third side edge L3 is fixedly connected to the second side edge L2 of the second mask body 50b, and the fourth side edge L4 corresponds to the first side edge L1 of the second mask body 50b. The second connection structure 71 is arranged on the fourth side edge L4 of the third mask body 70 and corresponds to the first connection structure 53. The second connection structure 71 and the first connection structure 53 are separable from and connectable to each other, so that the fourth side edge L4 of the third mask body 70 is detachably connected to the first side edge L1 of the second mask body 50b. This embodiment can further include a third connection structure 60 arranged on the first mask body 10c and close to the opening 11. FIG. 17 is a schematic diagram of the back side of the second mask body of FIG. 16 connected to the front side of the first mask body. It should be noted that the second mask body 50b and the third mask body 70 in FIG. 17 are shown as the back side, which is opposite to FIG. 16, so the positions of the first through-hole 51 and the second through-hole 52 are opposite to that of FIG. 16. Similarly, the first mask body 10c in FIG. 17 is shown as the front side, which is the same side as FIG. 16. Please refer to FIG. 17. The second mask body 50b is easily detachable from the third connection structure 60a of the first mask body 10c via a connection structure 52a. Please refer to FIG. 15 and FIG. 16 again. When the second mask body 50b and the first mask body 10c are combined, the second mask body 50b closes the opening 11 of the first mask body 10c. The second mask body 50b has a first through-hole 51 and a second through-hole 52. The positions of the first through-hole 51 and the second through-hole 52 correspond to the mouth position of the user. In addition, the epidemic prevention mask of this embodiment can further include two straps 40 respectively connected to the left and right sides of the first mask body 10c. The two straps 40 are used to loop around the ears of the user so that the first mask body 10c can be fixed to the mouth and nose position of the user.

As shown in FIG. 16, the first connection structure 53 can further have a first dividing part 51a arranged on the second mask body 50b and positioned between the first through-hole 51 and the second through-hole 52. The second connection structure 71 further has a second dividing part 71a positioned on the third mask body 70 and separable from and connectable to the first dividing part 51a. The second dividing part 71a divides the third mask body 70 into a first part 701 covering the first through-hole 51 and a second part 702 covering the second through-hole 52, and the first part 701 is adapted to be lifted from the second mask body 50b. The first part 701 is adapted to be lifted from the second mask body 50b by taking the first dividing part 51a and the second dividing part 71a connected to each other as an axis. Specifically, the third mask body 70 is positioned on the outside surface of the second mask body 50b, and one side (for example, the third side edge L3) of the third mask body 70 is connected to one side (for example, the second side edge L2) of the outside surface of the second mask body 50b. The other side (for example, the fourth side edge L4) of the third mask body 70 and the other side of the outside surface of the second mask body 50b (for example, the first side edge L1) form an easily detachable combination via the second connection structure 71. When in use, the third mask body 70 is lifted from the second mask body 50b (as shown in FIG. 16), so that the first through-hole 51 and the second through-hole 52 on the second mask body 50b are exposed. The first through-hole 51 can be used to insert a cigarette or a straw, and the cigarette or a straw passes through the opening 11 of the first mask body 10c, so the user can perform functions such as smoking or drinking. The second through-hole 52 can be used to expel the gas exhaled by the smoking user. With regard to the application of the structure of this embodiment, the second mask body 50b and the third mask body 70 can be disassembled and replaced when the replacement is necessary, which is also convenient for manufacturing.

The epidemic prevention mask having smoking and drinking functions provided by this embodiment includes a first mask body 10c having an opening 11, a second mask body 50b having through-holes (for example, including the first through-hole 51 and the second through-hole 52), and a third mask body 70 covering the through-holes, wherein the through-holes are communicated with the opening 11. When wearing the epidemic prevention mask, the user can lift the third mask body 70 from the second mask body 50b to expose the through-holes of the second mask body 50b, so that the user can smoke or drink a beverage while wearing the epidemic prevention mask. As a result, the user can directly smoke or drink a beverage while wearing the epidemic prevention mask, which is more convenient to use.

In summary, the epidemic prevention mask according to an embodiment of the invention uses the hole-covering part to cover the through-holes on the first mask body, so that the through-holes can be used as quasi-through-holes. Therefore, if the user wants to smoke or drink a beverage while wearing the epidemic prevention mask, the user can push through the quasi-through-hole to form a through-hole and insert a cigarette or straw into the through-hole, or lift the hole-covering part via the second mask body to expose the through-hole. Thus, the user can smoke or drink a beverage through the through-hole. In addition, the invention further provides an epidemic prevention mask having smoking and drinking functions, which includes a first mask body having an opening, a second mask body having through-holes, and a third mask body covering the through-holes, wherein the through-holes are communicated with the opening. When wearing the epidemic prevention mask, the user can lift the third mask body from the second mask body 50b to expose the through-hole of the second mask body, so that the user can smoke or drink a beverage while wearing the epidemic prevention mask. Based on the above, the user can directly smoke or drink beverages while wearing the epidemic prevention mask, which is more convenient to use. As a result, the user can directly smoke or drink a beverage while wearing the epidemic prevention mask, which is more convenient to use. In addition, the through-holes of the first mask body of the invention can be isolated from the outside by the second mask body or the protective tape to ensure that the user is less likely to inhale external contaminated air and to further achieve epidemic prevention. Therefore, the invention essentially provides an epidemic prevention mask having smoking and drinking functions, which has a film peeling structure and a push-through structure and is safe and hygienic. The invention has the following advantages: 1. the first mask body, the second mask body, and the third mask body do not add or mix with other materials, so the work is simple, the cost is reduced, and a good accessibility is provided; 2. according to the trend of modern people's pursuit of fashion, the second mask body and the third mask body of the invention provide new trendy appearance and aesthetic patterns, which makes everyone willing to wear and relieve the government from worrying that people do not like to wear a common mask.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An epidemic prevention mask having smoking and drinking functions, comprising:
a first mask body, adapted to cover a mouth position and a nose position of a user, wherein the first mask body has at least one through-hole corresponding to the mouth position; and
at least one hole-covering part, connected to a hole edge of the at least one through-hole and covering the at least one through-hole.

2. The epidemic prevention mask having smoking and drinking functions according to claim 1, further comprising a film peeling structure and a second mask body, wherein the second mask body is combined with the first mask body and connected to the at least one hole-covering part, and the second mask body is adapted to be lifted from the first mask body and remove the at least one hole-covering part to expose the at least one through-hole.

3. The epidemic prevention mask having smoking and drinking functions according to claim 2, further comprising a first connection structure and a second connection structure, wherein the second connection structure is arranged on a side edge of the second mask body, the first connection structure is arranged on the first mask body and corresponds to the second connection structure, and the first connection structure and the second connection structure are separable from and connectable to each other.

4. The epidemic prevention mask having smoking and drinking functions according to claim 3, wherein
the at least one through-hole comprises a first through-hole and a second through-hole, the at least one hole-covering part comprises a first hole-covering part and a second hole-covering part, the first hole-covering part covers and is connected to a hole edge of the first through-hole, and the second hole-covering part covers and is connected to a hole edge of the second through-hole,
the first connection structure further has a first dividing part arranged on the first mask body and located between the first through-hole and the second through-hole, the second connection structure further has a second dividing part on the second mask body, the first dividing part and the second dividing part are separable from and connectable to each other, the second dividing part divides the second mask body into a first part connected to the first hole-covering part and a second part connected to the second hole-covering part, and
the first part and the second part are adapted to be lifted from the first mask body by taking the first dividing part and the second dividing part connected to each other as an axis.

5. The epidemic prevention mask having smoking and drinking functions according to claim 3, further comprising a first positioning structure and a second positioning structure, wherein the second positioning structure is arranged on a side edge of the second mask body, the first positioning structure is arranged on the first mask body and corresponding to the second positioning structure, and the first positioning structure and the second positioning structure are adapted to slot to each other.

6. The epidemic prevention mask having smoking and drinking functions according to claim 3, further comprising a body connection structure, wherein the second mask body has a plurality of edges, the body connection structure is arranged on one of the plurality of edges of the second mask body, the second connection structure is arranged on the other of the plurality of edges of the second mask body, and the body connection structure is fixedly connected to the first mask body.

7. The epidemic prevention mask having smoking and drinking functions according to claim 1, wherein each of the at least one hole-covering part has a film peeling structure and a push-through structure, the film peeling structure comprises a pre-cut opening corresponding to the at least one through-hole, and the push-through structure comprises a pre-cut line.

8. The epidemic prevention mask having smoking and drinking functions according to claim 1, further comprising a second mask body and at least two guide way structures opposite to each other, wherein the at least two guide way structures are arranged inside the first mask body or on an outside surface of the first mask body, the second mask body is connected to the at least two guide way structures and is adapted to overlap the at least one hole-covering part, and the second mask body is adapted to move along the at least two guide way structures.

9. An epidemic prevention mask having smoking and drinking functions, comprising:
a first mask body, having an opening corresponding to a mouth position of a user;
a second mask body, connected to the first mask body and covering the opening, wherein the second mask body has at least one through-hole corresponding to the opening, and the second mask body further has a first side edge and a second side edge opposite to each other;
a first connection structure, arranged on the first side edge of the second mask body;
a third mask body, having a third side edge and a fourth side edge opposite to each other, wherein the third side edge is fixedly connected to the second side edge of the second mask body, and the fourth side edge corresponds to the first side edge of the second mask body; and
a second connection structure, arranged on the fourth side edge of the third mask body and corresponding to the first connection structure, wherein the second connection structure and the first connection structure are separable from and connectable to each other, so that the fourth side edge of the third mask body is detachably connected to the first side edge of the second mask body.

10. The epidemic prevention mask having smoking and drinking functions according to claim 9, wherein
the at least one through-hole comprises a first through-hole adjacent to the first side edge of the second mask body and a second through-hole adjacent to the second side edge of the second mask body,
the first connection structure further has a first dividing part arranged on the second mask body and positioned between the first through-hole and the second through-hole, the second connection structure further has a second dividing part arranged on the third mask body, the second dividing part and the first dividing part are separable from and connectable to each other, the second dividing part divides the third mask body into a first part covering the first through-hole and a second part covering the second through-hole, and the first part is adapt to be lifted from the second mask body, and
the first part is adapted to be lifted from the second mask body by taking the first dividing part and the second dividing part connected to each other as an axis.
